(19) United States
(12) Patent Application Publication
(10) Pub. No.: US 2020/0086366 A1
(43) Pub. Date: Mar. 19, 2020

(54) LANDFILL GAS WELLHEAD

(71) Applicant: Brian DeJean, New Orleans, LA (US)

(72) Inventor: Brian DeJean, New Orleans, LA (US)

(21) Appl. No.: 16/574,872

(22) Filed: Sep. 18, 2019

Related U.S. Application Data
(60) Provisional application No. 62/732,631, filed on Sep. 18, 2018.

(51) Int. Cl. B09C 1/00; E21B 33/03; E21B 34/02; E21B 47/06; B09B 1/00

(52) U.S. Cl. CPC B09C 1/005; E21B 33/03; E21B 34/02; E21B 2034/002; E21B 47/065; B09B 1/006; E21B 47/06

(57) ABSTRACT

A wellhead operable for extracting landfill gas from a landfill is provided. The wellhead includes a base portion operable to connect to a landfill gas well, the base portion defining an aperture for fluid communication with the landfill gas well. A conduit is connected to the base, the conduit defining an internal passage for flow of landfill gas from the landfill gas well. A plurality of ports is disposed around a periphery of the connection between the conduit and the base. A flow regulator valve is disposed within the conduit and a ball valve is connected to the conduit. Embodiments include construction of the base portion, the conduit portion, ports, and valves to collectively form a solid contiguous body and are made from a corrosion resistant material.

### CROSS REFERENCE TO RELATED APPLICATIONS

This application claims priority to U.S. Provisional Patent Application No. 62/732,631, filed Sep. 18, 2018, the entirety of which is hereby incorporated by reference.

### BACKGROUND

Recently, landfills of municipal solid waste (MSW) have served as a source of renewable energy by filtering methane gas from the Landfill Gas (LFG) that is a natural byproduct of the decomposition of organic material in anaerobic (without oxygen) conditions. Typically, LFG contains roughly 50-55% methane, 40-45% carbon dioxide, and the remainder consists of non-methane organic compounds. In order to generate LFG, the landfill of MSW is closed to additional waste placement, and collection piping systems in the form of either vertical or horizontal wells are installed in the enclosed landfill. Additional piping is also installed to provide vacuum pressure, supplied by a gas plant, to the wells.

Using the supplied vacuum, the LFG will flow through the underground piping system and exit the landfill at an extraction point on the surface above the well, which is capped with a wellhead used to regulate the LFG exiting the well. Generally, these wellheads are primarily composed of tubes and other component parts made from some form of plastic. Since these wellheads are above ground and exposed, the natural wear caused by the environment in combination with the pulled LFG flowing through the wellhead often leads to stress cracks and other failures in the wellhead.

Accordingly, there is a need for a wellhead that is more resistant to the harmful effects of the environment, capable of pulling LFG without leaks, and configured to allow for the regulation of LFG flowing through the wellhead.

### SUMMARY OF INVENTION

The present invention seeks to meet these needs by providing a wellhead manufactured primarily from stainless steel, or some other material with comparable resistant properties.

In accordance with embodiments of the invention, a wellhead operable for extracting landfill gas from a landfill is provided. The wellhead includes a base portion operable to connect to a landfill gas well, the base portion defining an aperture for fluid communication with the landfill gas well. A conduit is connected to the base, the conduit defining an internal passage for flow of landfill gas from the landfill gas well. Ports are disposed around a periphery of the connection between the conduit and the base. A flow regulator valve is disposed within the conduit and a ball valve is connected to the conduit.

In one embodiment, the base portion and the conduit portion are constructed of a solid body.

In another embodiment, the conduit has a first end opposite a second end, wherein the first end is a neck portion, and the second end is a feeder portion.

In a further embodiment, the feeder portion is configured in the shape of a right angle.

In one embodiment, at least one of the plurality of ports is operable for attachment to a liquid pump.

In another embodiment, at least one of the plurality of ports is operable for attachment to a ventilator.

In a further embodiment, at least one of the plurality of ports is operable for attachment to a pneumatic pump.

In one embodiment, at least one of the plurality of ports is operable for attachment to a water measurement device.

In another embodiment, the base portion is a flange.

In a further embodiment, the base portion and conduit are made of a corrosion resistant metal.

In one embodiment, the base portion and conduit are made of steel.

In another embodiment, a ball valve is connected to and in fluid communication with the internal passage of the conduit.

In a further embodiment, a pressure gauge is connected to and in fluid communication with the internal passage of the conduit.

In one embodiment, a temperature gauge is connected to and in fluid communication with the internal passage of the conduit.

In a further embodiment, a plurality of connecting ports is in fluid communication with the internal passage of the conduit.

In accordance with embodiments of the invention, a wellhead operable for extracting landfill gas from a landfill is provided. The wellhead includes a base portion operable to connect to a landfill gas well and the base portion define an aperture for fluid communication with the landfill gas well. A conduit connected to the base and defines an internal passage for flow of landfill gas from the landfill gas well. A plurality of ports is disposed around a periphery of the connection between the conduit and the base. A flow regulator valve is disposed within the conduit. A ball valve is connected to the conduit. The base portion, the conduit portion, ports, and valves collectively form a solid contiguous body and are made from a corrosion resistant material.

In one embodiment, the base portion and conduit are made of steel.

In another embodiment, the base portion and conduit are made of cast iron.

In further embodiment, the base portion and conduit are made of aluminum.

In one embodiment, base portion and conduit are made of polymers.

In one embodiment, the base portion and conduit are made of plastic.

### BRIEF DESCRIPTION OF THE DRAWINGS

FIG. 1 is a perspective view of a wellhead in accordance with embodiments of the invention.

FIG. 2 is an alternate perspective view of a wellhead in accordance with embodiments of the invention.

FIG. 3 is a profile view of a wellhead in accordance with embodiments of the invention.

FIG. 4 is an alternative profile view of a wellhead in accordance with embodiments of the invention.

FIG. 5 is a focused perspective view of the base portion of a wellhead in accordance with embodiments of the invention.

### DETAILED DESCRIPTION OF THE INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

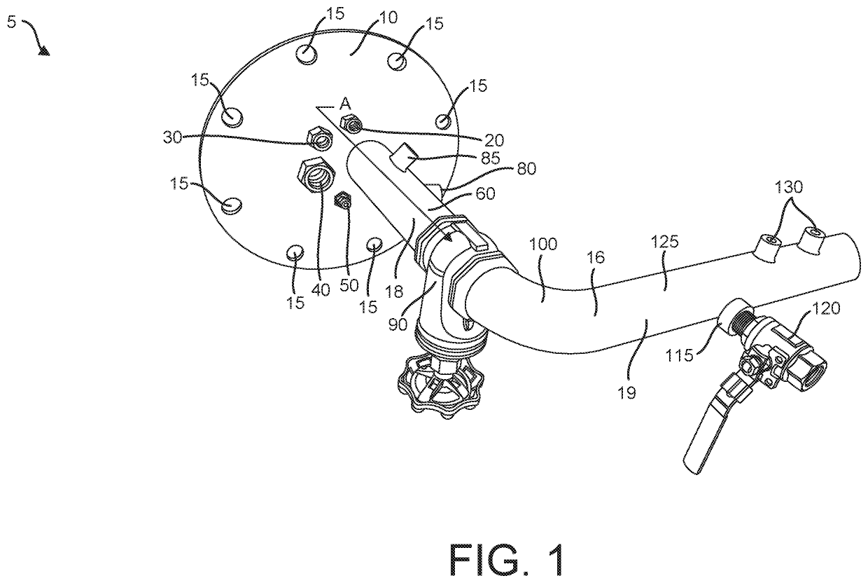

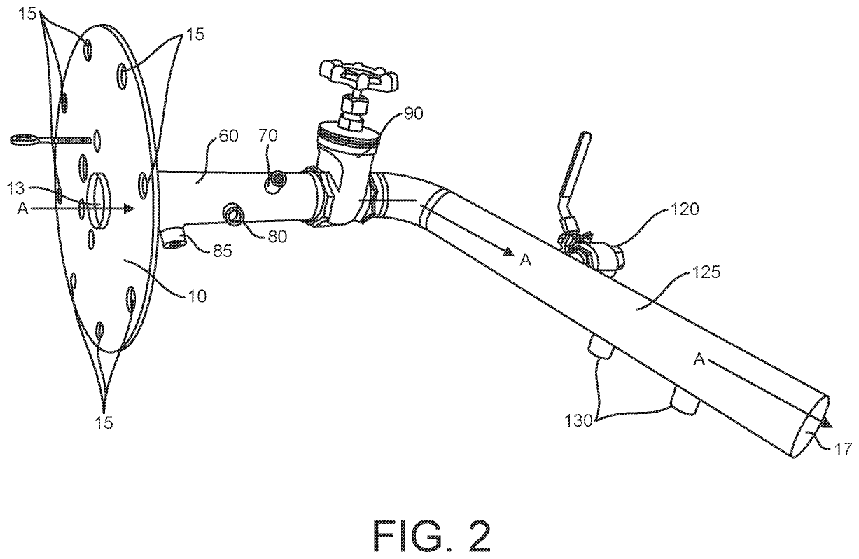

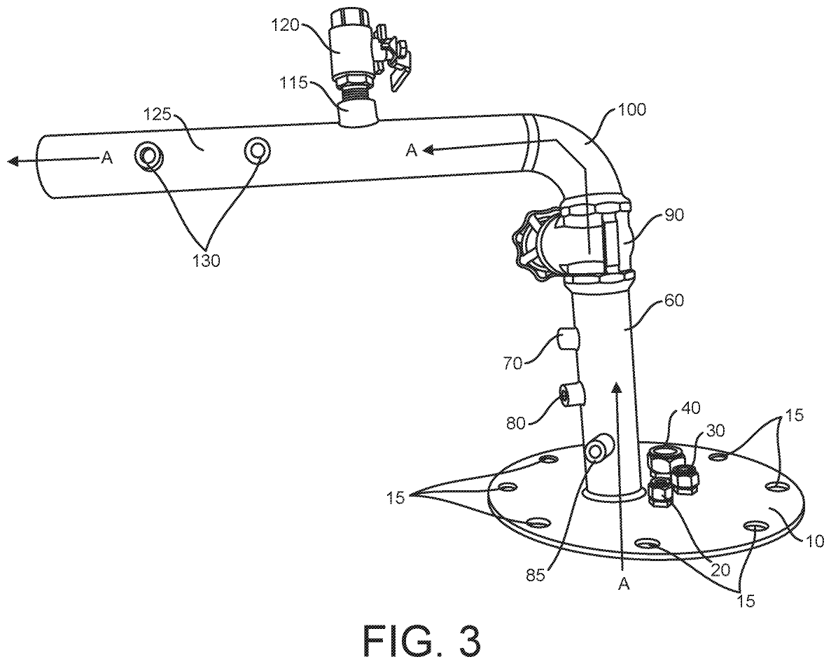

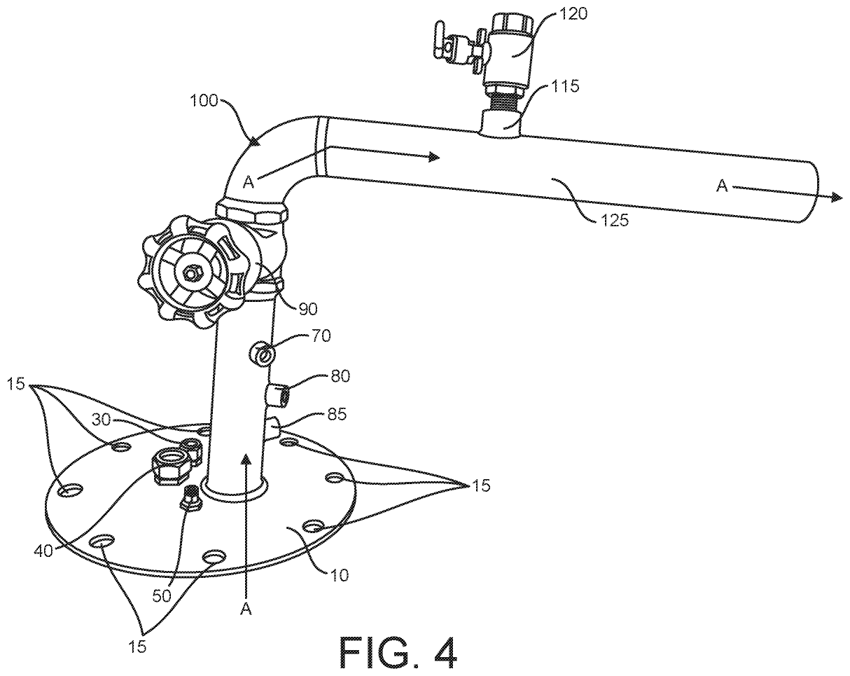

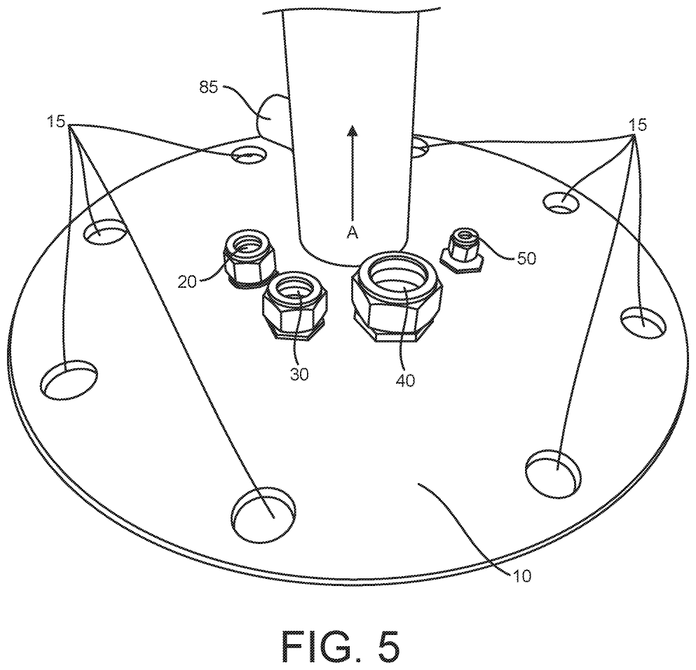

In accordance with embodiments of the invention, a well head 5 operable for extracting landfill gas from a landfill is provided. Referring to the embodiments illustrated in FIGS. 1-5, The well head 5 includes a base portion 10 operable to connect to a landfill gas well (not shown), the base portion defining an aperture 13 for fluid communication with the landfill gas well. Aperture 13 is illustrated in FIG. 2. The base 10 further defines a series of apertures 15 around the periphery of the base 10 operable to receive fasteners to attach to the base of a well. In one embodiment, the base 10 is a flange and the apertures 15 are bolt holes. Attaching the wellhead 5 to a gas well is generally accomplished through a nut and bolt system where the bolt is threaded through the apertures 15, but other securing or fastening methods used to connect bases of varying diameters known in the art could also be used.

In an embodiment, a conduit 16 is connected to the base 10, the conduit 16 defining an internal passage for flow of landfill gas from the landfill gas well in the direction of arrow A. A plurality of ports 20, 30, 40, and 50 is disposed around a periphery of the connection between the conduit 16 and the base 10 and in fluid communication with the landfill gas well, providing direct access into the well without the presence of a leak. In one embodiment, a flow regulator valve 90 is disposed within the conduit. In one embodiment, a ball valve 120 is connected to the conduit 16 to enable fluid communication conduit internal passage 17 to allow for selectively bleeding the well head 5, for example. The LFG that flows through the neck portion 60 can be regulated by any type of flowrate regulator valve 90 known in the art, e.g. a globe valve or gate valve.

In one embodiment, the base portion 10 and the conduit portion 16 are constructed of a solid body, such as by metal casting or by welding the conduit 16 to the base portion 15. In one embodiment, the base portion 10 and the conduit portion 16 are made from a corrosion resistant material, such as stainless steel. Embodiments include fabrication from metals including aluminum, iron and steel, including stainless steel and welded components, for example. Embodiments further include fabrication from polymers, plastics, and rubbers, depending on application-specific requirements, including pressure rating and corrosion resistant requirements.

In another embodiment, the conduit 16 has a first end 18 opposite a second end 19, the first end 18 is a neck portion 60 and the second end 19 is a feeder portion 125. The feeder portion 125 further includes at least one threaded outlet 115 that a ball valve 120, or some other comparable valve, is secured to. The ball valve 120 can be used in connection with a thermal mass flow meter (not shown) to measure the flow rate of the LFG through the feeder portion 125 of the wellhead.

In a further embodiment, the feeder portion 125 is configured in the shape of a right angle. Alternate angles may be used depending on the application, as the present invention enables a user to selectively manufacture the wellhead 5 for specific applications.

In one embodiment, the ports 20, 30, 40, and 50 are configurable for various tool attachments. For example, as illustrated in FIGS. 1-5, port 20 is a ventilator port, port 30 is a pneumatic port, port 40 is operable for attachment to a liquid pump, and port 50 is operable for attachment to a water measurement device. These ports are operable to connect to, for example, a typical ventilator (not shown), a pneumatic pump (not shown), a liquid pump (not shown), and/or a water measurement device (not shown), or other diagnostic tools or utilities needed to service the well. The plurality of optional connections to pumps, vents, and measurement devices enable a user to monitor, for example, internal pressure differentials, temperature, and flowrate as LFG flows through the piping of the wellhead.

In another embodiment, a ball valve 120 is connected to and in fluid communication with the internal passage of the conduit.

In a further embodiment, a pressure gauge is operable to connect to the pressure gauge port 70 and is in fluid communication with the internal passage of the conduit.

In one embodiment, a temperature gauge is operable to connect to the temperature gauge port 80 and is in fluid communication with the internal passage of the conduit.

In another embodiment, a sample port 85 is operable for sampling the LFG flow and is in fluid communication with the internal passage of the conduit.

In a further embodiment, a plurality of connecting ports 130 is in fluid communication with the internal passage 17 of the conduit 16 to allow access to the flow of LFG. For example, one of the connecting ports 130 can be used to tie into a pressure meter for testing pressure differentials across the ports 130 and 85, and the other port 130 can be used to connect another pressure gauge.

Once the base portion is secured to the vertical or horizontal well, LFG will flow in the direction of arrow A through the piping of the wellhead, which includes a neck portion 60, an elbow 100 and a feeder portion 125 that will tie into the existing piping system used to transport the LFG to a processing facility.

For the purposes of promoting and understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical.” Numerous modifications and adaptations will be readily apparent to those skilled in this art without departing from the spirit and scope of the present invention.

1. A wellhead operable for extracting landfill gas from a landfill, comprising:
a base portion operable to connect to a landfill gas well, said base portion defining an aperture for fluid communication with the landfill gas well;
a conduit connected to the base, said conduit defining an internal passage for flow of landfill gas from the landfill gas well;
a plurality of ports disposed around a periphery of the connection between the conduit and the base;
a flow regulator valve disposed within the conduit; and
a ball valve connected to the conduit.

2. The wellhead of claim 1, wherein the base portion and the conduit portion are constructed of a solid body.

3. The wellhead of claim 1, wherein the conduit comprises a first end opposite a second end, the first end comprising a neck portion and the second end comprising a feeder portion.

4. The wellhead of claim 3, wherein the feeder portion is configured in the shape of a right angle.

5. The wellhead of claim 1, wherein at least one of the plurality of ports is operable for attachment to a liquid pump.

6. The wellhead of claim 1, wherein at least one of the plurality of ports is operable for attachment to a ventilator.

7. The wellhead of claim 1, wherein at least one of the plurality of ports is operable for attachment to a pneumatic pump.

8. The wellhead of claim 1, wherein at least one of the plurality of ports is operable for attachment to a water measurement device.

9. The wellhead of claim 1, wherein the base portion is a flange.

10. The wellhead of claim 1, wherein the base portion and conduit are made of a corrosion resistant metal.

11. The wellhead of claim 1, wherein the base portion and conduit are made of steel.

12. The wellhead of claim 1, further comprising a pressure gauge connected to and in fluid communication with the internal passage of the conduit.

13. The wellhead of claim 1, further comprising a temperature gauge connected to and in fluid communication with the internal passage of the conduit.

14. The wellhead of claim 1, further comprising a plurality of connecting ports in fluid communication with the internal passage of the conduit.

15. A wellhead operable for extracting landfill gas from a landfill, comprising:
a base portion operable to connect to a landfill gas well, said base portion defining an aperture for fluid communication with the landfill gas well;
a conduit connected to the base, said conduit defining an internal passage for flow of landfill gas from the landfill gas well;
a plurality of ports disposed around a periphery of the connection between the conduit and the base;
a flow regulator valve disposed within the conduit; and
a ball valve connected to the conduit,
wherein the base portion, the conduit portion, ports, and valves collectively form a solid contiguous body and are made from a corrosion resistant material.

16. The wellhead of claim 15, wherein base portion and conduit are made of steel.

17. The wellhead of claim 15, wherein base portion and conduit are made of cast iron.

18. The wellhead of claim 15, wherein base portion and conduit are made of aluminum.

19. The wellhead of claim 15, wherein base portion and conduit are made of polymers.

20. The wellhead of claim 15, wherein base portion and conduit are made of plastic.
